(19) United States
(12) Patent Application Publication
(10) Pub. No.: US 2004/0168086 A1
(43) Pub. Date: Aug. 26, 2004

(54) Interactive security risk management

(76) Inventors: Carl Young, New York, NY (US); Phillip Venables, New York, NY (US)

Correspondence Address: Clifford Chance US LLP, 200 Park Avenue, New York, NY, 10166-0153, US

(21) Appl. No.: 10/737,217

(22) Filed: Dec. 15, 2003

Related U.S. Application Data
(60) Provisional application No. 60/434,343, filed on Dec. 18, 2002.

(51) Int. Cl. G06F 11/30

(52) U.S. Cl. 713/201

(57) ABSTRACT

The present invention includes computer implemented methods and computer apparatus for managing security risk by setting a hierarchical relationship between two or more elements comprising an entity and receiving an indication of a security risk associated with one or more of the elements. A selection of an element can also be received and a description of the security risk can be transmitted, as it relates to the element selected and based upon the hierarchical relationship of elements and the indication of the security risk. A list of resources associated with the element selected can also be generated. Elements can include, for example, a geographic area delineated according to at least one of: a continent, a national boundary; a political boundary, a facility campus; a floor comprising a facility; and a room comprising a building.

### CROSS REFERENCE TO RELATED APPLICATIONS

This application claims priority to U.S. Provisional Application No. 60/434,343 filed Dec. 18, 2002 and entitled “Interactive Security Risk Management”.

### BACKGROUND

This invention relates generally to methods and systems for facilitating management of security risks to one or more facilities and the resources associated with the facilities. In particular, the present invention relates to computer implemented methods for providing detailed views of security threats and vulnerabilities around the world.

Threats of many kinds can affect a facility. Increasingly, facilities face the risk of a security breach for attack from acts of terrorism, acts of war, corporate or national espionage or other manmade cause. In addition, natural phenomenon such as a hurricane, tornado, snow storm or volcanic eruption can also threaten a facility. Monitoring the extent of such threats and potential consequences of such threats may pose a daunting task. Typically, facility security is handled on a local level. Many facilities, and in particular smaller secondary or tertiary level facilities do not have the resources to monitor the many sources from which a security threat may be received.

In addition, globalization of many businesses or other organization can result in an entity in one part of the world that is exposed to security threats in many other parts of the world. For example, a U.S. company may be dependent on goods manufactured in an emerging nation. The U.S. company may experience a risk exposure related to security of the facility in that emerging nation. Current systems do not provide an accurate method for sufficiently associating facts that may equate into security risk for a facility on a global basis. In addition, they do not offer a way to assess what exposure an entity may face in the event of a security breach.

What is needed is methods and apparatus to provide an association of risk factors with potential security risks and also be able to assess exposure related to such risks.

### SUMMARY

Accordingly, the present invention includes computer implemented methods and computer apparatus for managing security risk by setting a hierarchical relationship between two or more elements comprising an entity and receiving an indication of a security risk associated with one or more of the elements. A selection of an element is also received and a description of the security risk is transmitted, as it relates to the element selected and based upon the hierarchical relationship of elements and the indication of the security risk. A list of resources associated with the element selected can also be generated.

In some embodiments, the element includes a geographic area delineated according to at least one of: a continent, a national boundary; a political boundary, a facility campus; a floor comprising a facility; and a room comprising a building. In addition, in some embodiments the description of the security risk as it relates to the element selected can include at least one of: a threat of physical harm to an asset; a threat of misappropriation of an asset; and a threat of physical harm to one or more persons.

In another aspect in some embodiments the description of the security risk as it relates to the element selected includes a misappropriation of information included in a computerized information system. Some embodiments can also include transmitting a subjective quantifier descriptive of an amount of harm that could be caused by the security risk. In still another aspect, transmitting a subjective quantifier descriptive of a time frame during which harm, caused by the security risk, could be experienced by an associated element.

Some embodiments can also be structured so that the hierarchical relationship between two or more elements includes a progressively greater or lesser resolution ranging from a country level resolution to a room level resolution.

Still other aspects can include receiving an image of an element and transmitting the image with the description of the security risk as it relates to the element selected.

Still other embodiments can include color coding elements and associated risks according to at least one of: a degree of risk, a type of risk, a type of element; a value of assets involved and propensity for the risk to grow.

Other, additional embodiments can include methods and apparatus for presenting a graphical user interface related to a facility and including one or more images of the facility, displaying security issues related to a geographic region comprising the location of the facility, indicating one or more proximate threats to the facility and displaying a relative location of at least one of: a public utility dependency; proximate emergency services, ingress routes, egress routes, and a proximate secure shelter.

Still other embodiments can include storing a time series of images of one or more particular portions of the facility and identifying changes to subsequent images of at least one area of the facility as compared to prior images such that a countermeasure to a threat can be determined based upon the identified changes.

Embodiments can also allow one or more records of proximate threats to a facility to be stored and a report can be generated that includes at least one of: an event log; an incident report; and facility history according to at least one of a facility level; a defined intra-national geographic area level; a national level; and a defined international level.

In still other embodiments a security risk associated with a facility can be managed by inputting an indication identifying a facility, receiving an indication of one or more security risks associated with the facility, inputting an indication of a subset of the facility, receiving information descriptive of the security risks specific to the subset of the facility and receiving an image of the subset of the facility.

Other embodiments of the present invention can include a computerized apparatus performing various steps and functions described, executable software on a computer readable medium and executable on demand to perform the various steps and functions described, or a data signal comprising digital data with commands that are interactive with a computer apparatus to implement the inventive methods of the present invention. The computer server can be accessed via a network access device, such as a computer. Similarly, the data signal can be operative with a computing device, and computer code can be embodied on a computer readable medium.

In another aspect, the present invention can include a method and system for a user to interact with an apparatus comprising a network access device so as to implement various inventive functions. Various features and embodiments are further described in the following figures, drawings and claims.

### DESCRIPTION OF THE DRAWINGS

FIG. 1 illustrates block diagrams of some embodiments of the present invention.

FIG. 2A illustrates a progressively greater or lesser resolution of detail of elements relating to security management.

FIG. 2B illustrates exemplary details of greater or lesser resolution of elements.

FIG. 3A illustrates a flow of exemplary steps that can be executed while implementing some embodiments of the present.

FIG. 3B illustrates a flow of additional, exemplary steps that can be executed while implementing some embodiments of the present.

FIG. 3C illustrates still further exemplary steps that can be executed while implementing some embodiments of the present.

FIG. 4 illustrates a network of computer systems that can be included in some embodiments of the present invention.

FIG. 5 illustrates a computerized device that can be utilized to implement some embodiments of the present invention.

FIG. 6 illustrates an exemplary graphical user interface that can implement various aspects of the present invention.

FIG. 7 illustrates an exemplary data structure that can be utilized to implement certain aspects of the present invention.

### DETAILED DESCRIPTION

Overview

The present invention includes a Security Threat Map (STM). The purpose of the STM is to provide security professionals, or other users, with a configurable, distributed, desktop tool that offers big picture and detailed views of the spectrum of security threats and vulnerabilities to facilities around the world.

The functionality of the STM can include, for example, a Web-based, or other computerized architecture, consisting of a series of graphical user interface (GUI) screens with embedded links showing facility locations and associated threats/vulnerabilities. Screens can have progressively greater or diminishing resolution ranging, for example, from a country-level to within-room perspective. The links can be hierarchical or relational. The present invention can include graphics and/or digital images with accompanying text, using color-coded indicators for worldwide “at-a-glance” security assessments. Standard security features can be implemented (password-protected, SSL, change control, etc.) to ensure information integrity and enforce access restrictions.

The content of an STM can include:

(1) International/global screens would note in-country facility locations with accompanying up-to-date information on the political situation that might affect the security of facilities so located. These can be refreshed via external feeds or internal updates.

(2) Building-level screens can contain “canned graphics” or digital photographs of actual facilities, and can highlight regional security issues, as well as indicate proximate threats and the location of public utility dependencies. Locations of emergency services and/or ingress/egress routes, as well as nearest secure facilities/shelters can also be included.

(3) Floor and room-level screens can contain images, such as, for example, digital photographs or graphic representations of the entire company infrastructure, and can note existing access control/surveillance equipment. Areas under immediate threat or vulnerability (e.g., a break-in, fire, explosion, etc.) and/or high sensitivity can be specially delineated while highlighting important and/or potentially compromised assets.

Some embodiments can also include a time series of digital images that can be stored for specific rooms/areas, such that identified changes can be used to focus on problem areas or assist in countermeasure inspections.

(4) A built-in statistical tracking mechanism and graphics package can automatically, or upon demand, produce event logs, incident reports and facility history on a building-level, regional, national or international basis.

Some embodiments of the present invention can enable security professionals, or other users to monitor threats and/or vulnerabilities to their facilities on a worldwide basis. Using this application, a security perspective can instantaneously range from high-level overviews to minute, in-depth detail. Threat status can be monitored and modified in real-time from anywhere in the world, with updated information made immediately available to those with access privileges. Regular changes and updates to the information can make this tool an indispensable part of the security infrastructure. This application can greatly enhance the threat assessment process, as well as facilitate status reporting or convey resource requirements to management.

Various embodiments can also include users that subscribe to external feeds and/or relevant databases for updates in return for an associated monthly subscription fees.

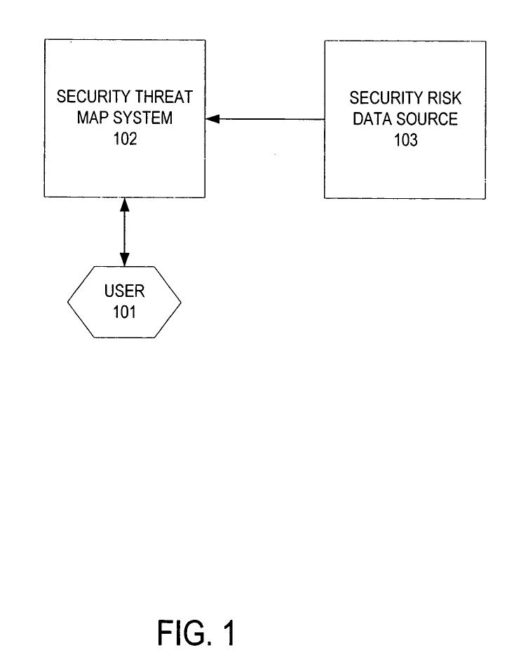

Referring now to FIG. 1A, a block diagram illustrates basic components of the present invention. A user 101 can access a computerized STM system 102 to view information relating to security risk or threat associated with a security element. The security element can include any definable geographic area, facility or resource or asset. A security risk can include any potential for physical, reputational, economic, legal or other harm.

A hierarchical relationship can be set up between any two or more elements, such that as a user traverses up or down the hierarchy, a different set or subset of elements will be selected and addressed. Data that describes one or more security risks for a selected element can be provided by the STM system 102 to the user. Generalized security risk data can be received from a security risk data source, which can include, for example, a government agency, a private investigation firm, public news, news feeds, internal security efforts, law enforcement agency or other source.

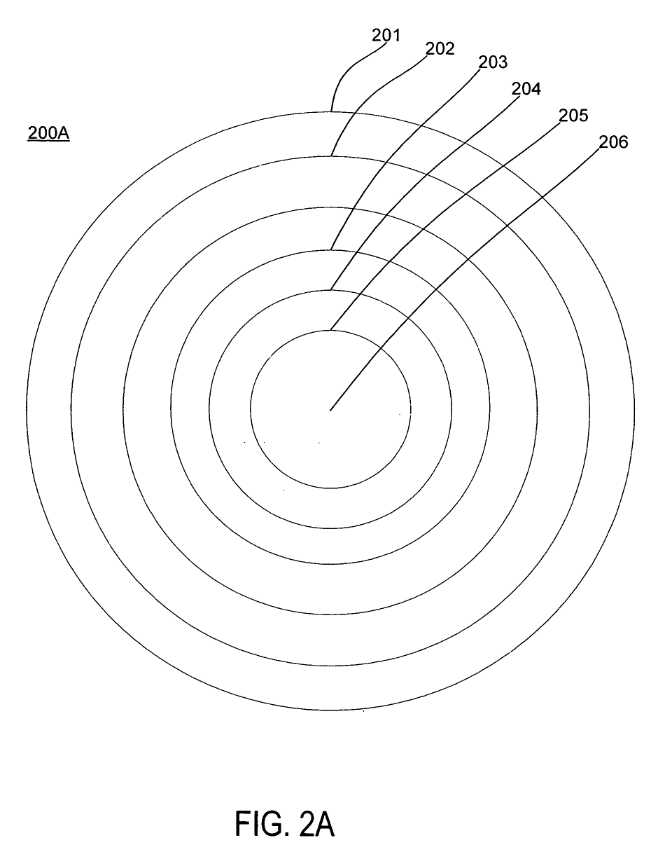

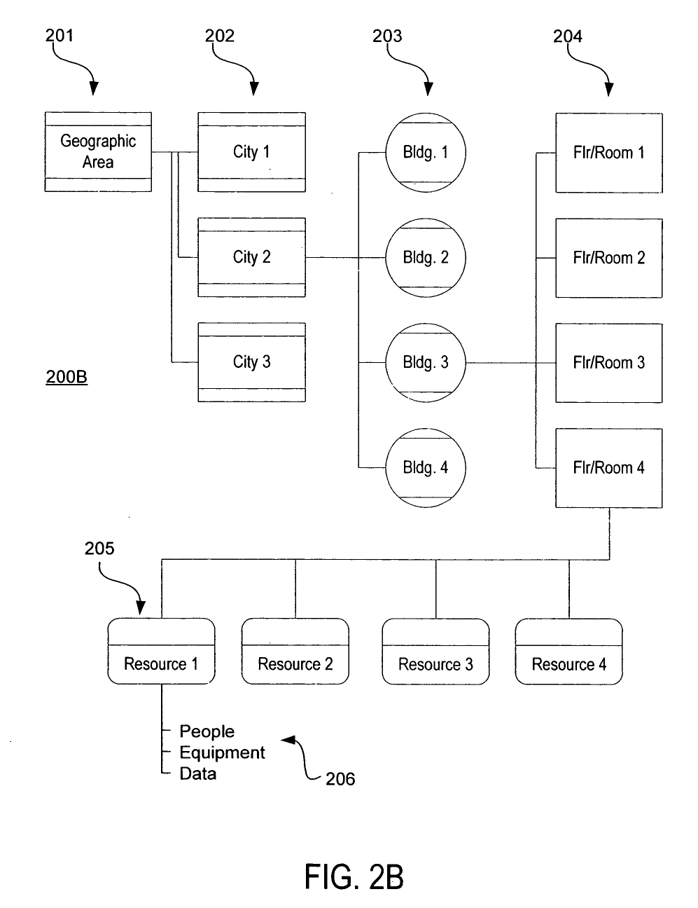

Referring now to FIG. 2A, a block diagram illustrates a series of hierarchical levels 210-206 that a user can traverse via the STM. Each hierarchical level can allow a user to zoom in or zoom out on a level of detail relating to security elements tracked by the STM. Each hierarchical level can be associated with various aspects of one or more security risks or threats. For example a high level i.e. 201 may include a large geographic region or nationally defined element and address those security risks that are related to the region or nation. A lower level i.e. 205 may include a particular floor of a specified building and include increased detail to security risks that are related to that particular building and floor.

FIG. 2B illustrates some exemplary embodiments of hierarchical levels in an STM and how the hierarchical levels can be associated with particular sets of elements 201-206. The STM can present informational data that relates to elements that are monitored by a particular security group, such as, assets owned by a company, or assets to be monitored under contract to a security firm. Traversing various elements can be accomplished via well known user interactive and GUI devices.

A high level 201 can include a set of elements that comprises a geographic area, such as, for example, North America. The geographic area 201 can be delineated along political, natural, or manufactured boundaries, such as above the 39th parallel, or a grid overlaying a map.

The high level geographic area 201 can include lower hierarchical levels 202-206. A user 101 can select any level 201-206 and jump to that level, or traverse each level up and down the hierarchy. Accordingly, one level below the geographic level 201 can include, for example, a set of elements that comprises a smaller geographic determination, such as, a city 202. The city 202 can in turn include still smaller subsets of elements, such as, facilities or buildings 203. Continuing downward through the exemplary hierarchy 200B, the buildings can include subsets of elements that include floors or rooms 204, and the floors or rooms 204 can include subsets of resources 205.

Resources 205, can include all things having economic or other value, such as money, property, goods or information. Examples of resources can include: information systems containing particular applications, wherein the applications may be mission critical, or merely supportive functions; equipment; people; information; data, functionality, such as a trading floor or manufacturing capability; or other asset of value. As such, resources can include further subsets, such as a subset that includes people, data, or equipment 206.

Methods

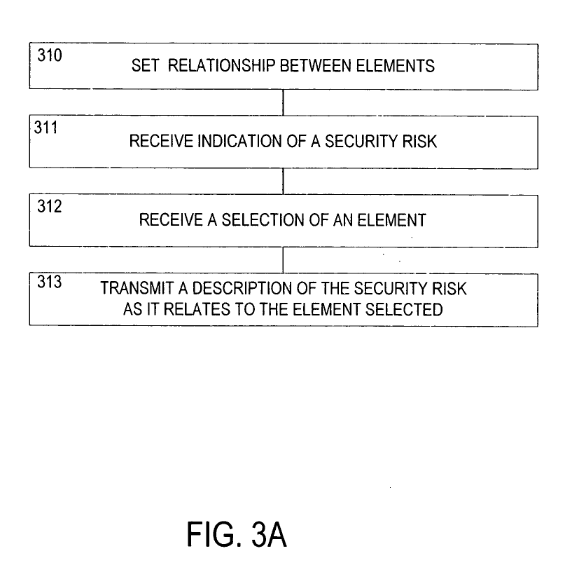

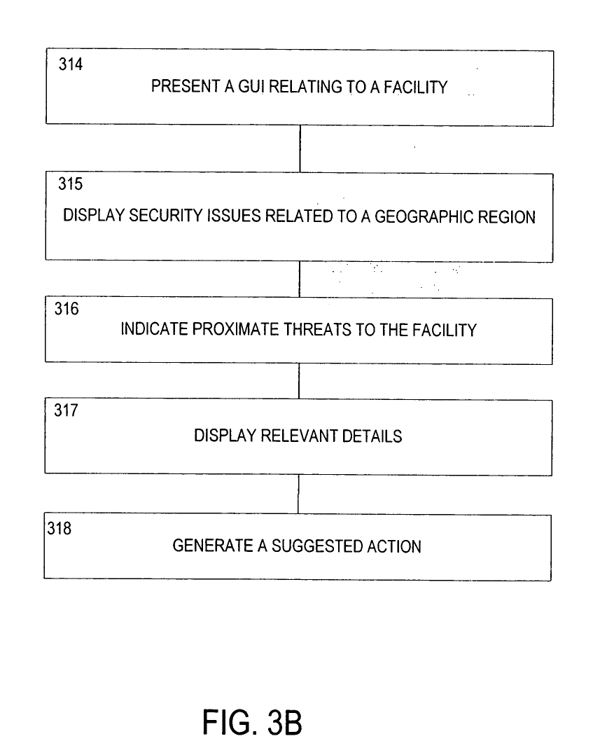

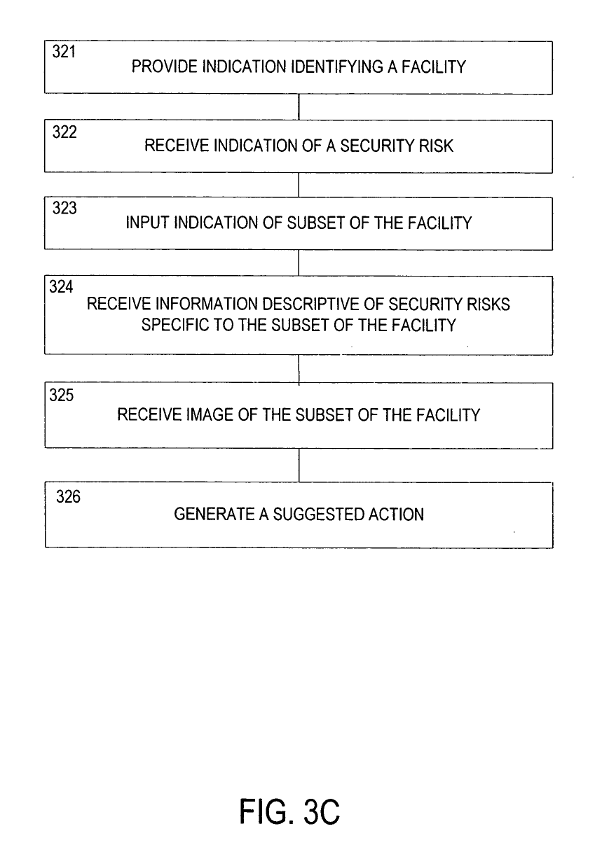

Referring now to FIG. 3, steps that can be performed while practicing the present invention are illustrated, the steps are presented as they may be practiced, although no particular order is required. Accordingly, any order should not limit the scope of the invention. In addition, the presentation is not to be limited by the steps included, which are meant to be exemplary and enabling.

At 310, a relationship can be set between elements included in the STM. The relationship can include a hierarchical relationship with defined subsets of subsets, or relational links that associate various datum or elements with other elements. At 311, the STM can receive an indication of a security risk. The indication of a security risk can include, for example, a warning from a government or law enforcement agency of terrorist activity, an act of war, evidence of corporate espionage, news reports of natural disasters, search results from a risk management clearinghouse, notification of a cyber attack or hacker activity, results from a private investigation, triggering of a security device, such as an alarm, notification of a breach of a defensive mechanism, or any other indication that a security risk exists for a particular element.

At 312, the STM can receive a selection of an element. The selection can be accomplished with any tool for accessing an automated system, such as, for example, a user pointing device (i.e. mouse, trackball etc), a keyboard, voice activation, voice prompt, wireless transmission, or other selection mechanism. At 313, the STM can transmit a description of one or more security risks that relate to the specific element selected. In addition, in some embodiments, a suggested action can be included to assist a user with how to respond to a security risk to a particular element.

Referring now to FIG. 3B, steps that can be performed in another aspect of the present invention are illustrated. At 314, the STM can present a GUI related to a facility, or other element. At 315, the STM can display one or more security issues to a parent set of the facility or other element, such as, for example, security issues relating to a geographic area. At 316, the STM can indicate any proximate threats to the facility selected and at 317, display any relevant security related details, such as, for example: a public utility dependency; proximate emergency services, ingress routes, egress routes, and a proximate secure shelter. Again, at 318, in some embodiments, a suggested action can also be generated.

Referring now to FIG. 3C, steps that can be performed while practicing the present invention, from the perspective of a user 101, are illustrated. At 321, the user 101 can provide an indication identifying a facility and at 322 receive and indication of one or more security risks. At 323, the user 100 can input a indication of a subset of the facility, such as, for example, a floor or room within the facility. At 324, the user can receive information that describes security risks specific to the subset.

At 325, the user can also receive an image of the facility or the subset of the facility. For example, a digital camera can be utilized to provide real time or periodic images of a selected facility or resource. In addition, time stamped images of a facility or resource can be compared utilizing well known automated techniques to ascertain any changes in the images over a span of time. Such changes can be analyzed to determine an appropriate response or counter-measure. At 326, a suggested action can also be generated.

Systems

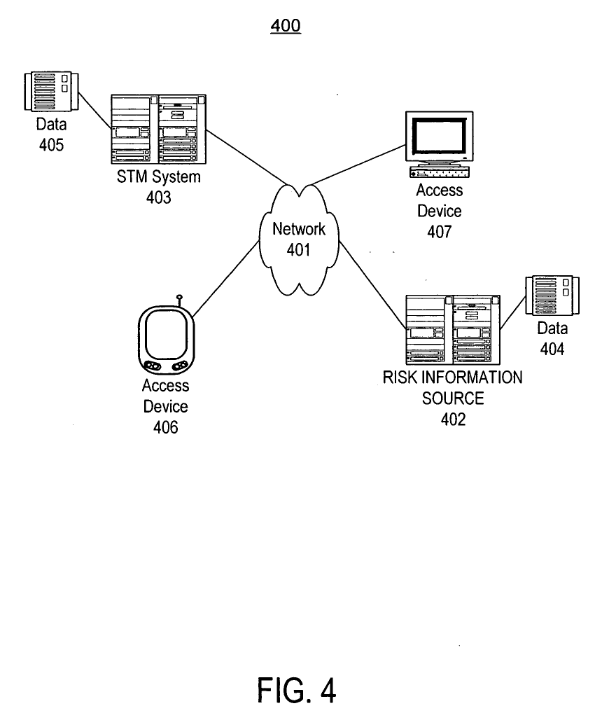

Referring now to FIG. 4, a network diagram illustrating one embodiment of the present invention is shown 400. An automated STM system 403 can include a computerized server accessible via a distributed network 401 such as the Internet, or a private network. A risk information source can also include a computerized server 402. A user can use a computerized system or network access device 406-407 to receive, input, transmit or view information processed in the STM system 403, a peer device, or other network access device 406-407. A protocol, such as, for example, the transmission control protocol internet protocol (TCP/IP) can be utilized to provide consistency and reliability.

A system access device 406-407 can communicate with the STM system 403 to access data and programs stored at the respective servers. A system access device 406-407 may interact with the STM system 403 as if the servers were a single entity in the network 400. However, the STM system 403 and risk information source system 402 may include multiple processing and database sub-systems, such as cooperative or redundant processing and/or database servers that can be geographically dispersed throughout the network 400.

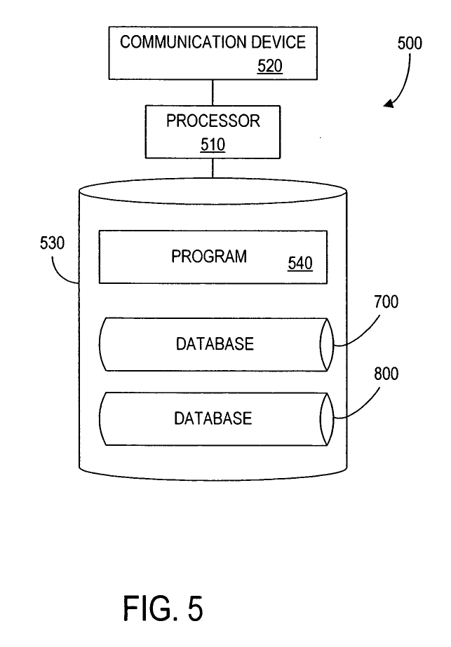

A server utilized in a STM system 403 can include a processor, memory and a user input device, such as a keyboard and/or mouse, and a user output device, such as a display screen and/or printer, as further detailed in FIG. 5. A server can also include one or more databases 404-405 storing data relating to an security risks or elements. Information relating to elements and/or security risks or other threats can be aggregated into a searchable data storage structure. Gathering data into an aggregate data structure 404-405, such as a data warehouse; allows a server to have the data readily available for processing. Aggregated data 404-405 can also be scrubbed or otherwise enhanced to aid in searching.

Typically, an access device 406-407 will access an STM system 403 using client software executed at the system access device 406-407. The client software may include a generic hypertext markup language (HTML) browser, such as Netscape Navigator or Microsoft Internet Explorer, (a “WEB browser”). The client software may also be a proprietary browser, and/or other host access software. In some cases, an executable program, such as a Java™ program, may be downloaded from a server to the system access device 406-407 and executed at the system access device 406-407. Other implementations include proprietary software installed from a computer readable medium, such as a CD ROM. The invention may therefore be implemented in digital electronic circuitry, computer hardware, firmware, software, or in combinations of the above.

FIG. 5 illustrates a controller 500 that is descriptive of the access devices shown, for example, in FIG. 4 according to some embodiments of the present invention. The STM controller 403 comprises a processor 510, such as one or more processors, coupled to a communication device 520 configured to communicate via a communication network (not shown in FIG. 5). The communication device 520 may be used to communicate, for example, with one or more network access devices 406-407.

The processor 510 is also in communication with a storage device 530. The storage device 530 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 530 can store a program 540 for controlling the processor 510. The processor 510 performs instructions of the program 540, and thereby operates in accordance with the present invention. For example, the processor 540 may receive information descriptive of an STM. The processor 510 may also transmit information.

The storage device 630 can store STM related data in a first database 700 and database 800, and other data as needed. The illustration and accompanying description of the STM related database presented herein is exemplary, and any number of other database arrangements can be employed besides those suggested by the figures.

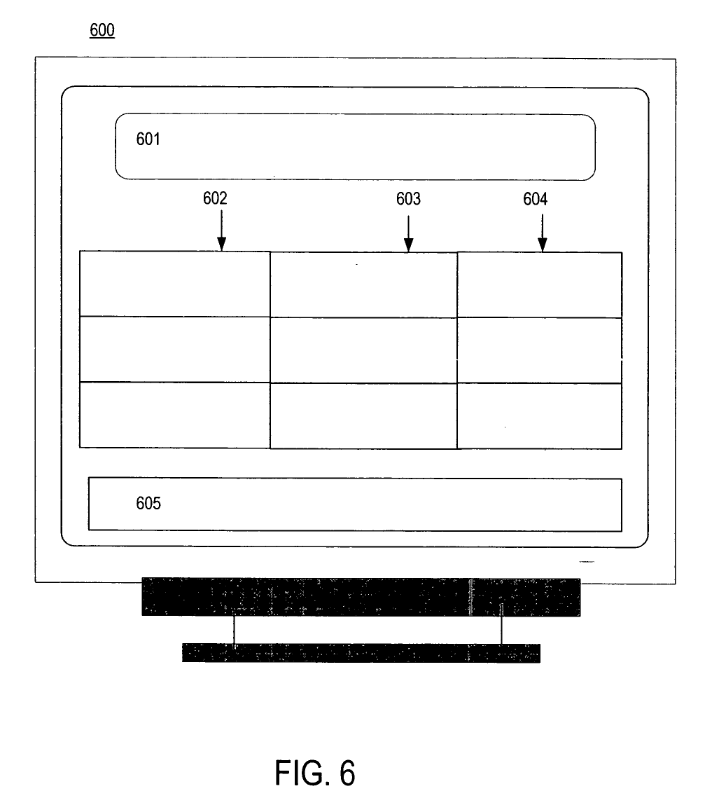

Referring now to FIG. 6, an exemplary GUI 600 that can be utilized while practicing the present invention is illustrated. The GUI can be presented on a network access device 406-407 or any other type of terminal or interactive station capable of creating a display pursuant to an electronic signal. A portion of display 601 can display information descriptive of an element. Another portion of the display 602 can include information descriptive of subsets of the element, such as facility data. Still another portion 603 can contain information descriptive of security risks or threats. Portions of the display 600 can also be interactive, and allow a user to input data, such as data indicative of an element to be selected.

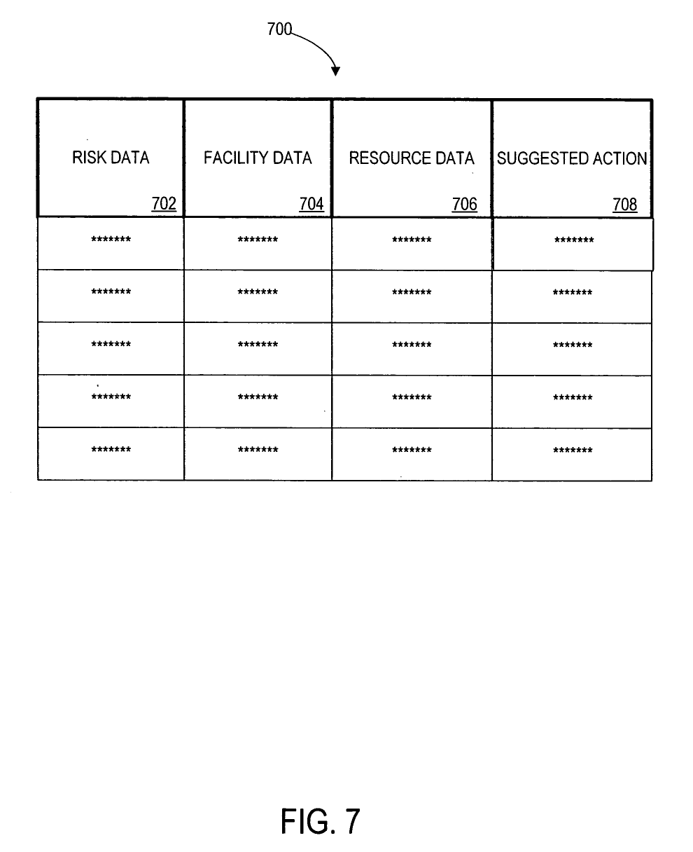

Referring now to FIG. 7, a design of a portion of database that can be utilized while implementing the present invention is illustrated. The database 700 can include a field containing data descriptive of a risk data 702 as well as a field containing data descriptive of a facility 704 and resource related data 706. Another field can hold data descriptive of suggested actions 708. Obviously, other data fields storing data utilized in various facets of the present invention can also be included. The data can be arranged and accessed using any known data storage and accessing techniques.

A number of embodiments of the present invention have been described. Nevertheless, it will be understood that various modifications may be made without departing from the spirit and scope of the invention.

Embodiments of the present invention can include a computerized system, executable software, or a data signal implementing the inventive methods of the present invention. The computer server can be accessed via a network access device, such as a computer. Similarly, the data signal can be operative with a computing device, and computer code can be embodied on a computer readable medium. Accordingly, other embodiments are within the scope of the following claims.

What is claimed is:

1. A computer implemented method for managing security risk, the method comprising:
setting a hierarchical relationship between two or more elements comprising an entity;
receiving an indication of a security risk associated with one or more of the elements;
receiving a selection of an element; and
transmitting a description of the security risk as it relates to the element selected, based upon the hierarchical relationship of elements and the indication of the security risk.

2. The method of claim 1 additionally comprising generating a list of resources associated with the element selected.

3. The method of claim 1 wherein the element comprises a geographic area delineated according to at least one of: a continent, a national boundary; a political boundary, a facility campus; a floor comprising a facility; and a room comprising a building.

4. The method of claim 1 wherein the description of the security risk as it relates to the element selected comprises at least one of: a threat of physical harm to an asset; a threat of misappropriation of an asset; and a threat of physical harm to one or more persons.

5. The method of claim 1 wherein the description of the security risk as it relates to the element selected comprises misappropriation of information comprising a computerized information system.

6. The method of claim 1 additionally comprising transmitting a subjective quantifier descriptive of an amount of harm that could be caused by the security risk.

7. The method of claim 1 additionally comprising transmitting a subjective quantifier descriptive of a time frame during which harm, caused by the security risk, could be experienced by an associated element.

8. The method of claim 1 wherein the hierarchical relationship between two or more elements comprises a progressively greater or lesser resolution ranging from a country level resolution to a room level resolution.

9. The method of claim 1 additionally comprising receiving an image of an element and transmitting the image with the description of the security risk as it relates to the element selected.

10. The method of claim 1 additionally comprising the steps of:
color coding elements and associated risks according to at least one of: a degree of risk, a type of risk, a type of element; a value of assets involved and propensity for the risk to grow.

11. A computer implemented method for managing a security risk associated with a facility, the method comprising:
presenting a graphical user interface related to a facility and comprising one or more images of the facility;
displaying security issues related to a geographic region comprising the location of the facility;
indicating one or more proximate threats to the facility; and
displaying a relative location of at least one of: a public utility dependency; proximate emergency services, ingress routes, egress routes, and a proximate secure shelter.

12. The method of claim 11 additionally comprising the steps of:
storing a time series of images of one or more particular portions of the facility;
identifying changes to subsequent images of at least one area of the facility as compared to prior images: and
determining a countermeasure to a threat based upon the identified changes.

13. The method of claim 11 additionally comprising the steps of:
storing a record of proximate threats to a facility; and
generating a report of at least one of: an event log; an incident report; and facility history according to at least one of: a facility level; a defined intra-national geographic area level; a national level; and a defined international level.

14. A method for managing security risk associated with a facility, the method comprising:
inputting an indication identifying a facility;
receiving an indication of one or more security risks associated with the facility;
inputting an indication of a subset of the facility;
receiving information descriptive of the security risks specific to the subset of the facility; and
receiving an image of the subset of the facility.

15. A computerized system for or managing security risk, the system comprising:
a computer server accessible with a system access device via a communications network; and
executable software stored on the server and executable on demand, the software operative with the server to cause the server to:
set a hierarchical relationship between two or more elements comprising an entity;
receive an indication of a security risk associated with one or more of the elements;
receive a selection of an element;
transmit a description of the security risk as it relates to the element selected, based upon the hierarchical relationship of elements and the indication of the security risk.

16. Computer executable program code residing on a computer-readable medium, the program code comprising instructions for causing the computer to:
set a hierarchical relationship between two or more elements comprising an entity;
receive an indication of a security risk associated with one or more of the elements;
receive a selection of an element;
transmit a description of the security risk as it relates to the element selected, based upon the hierarchical relationship of elements and the indication of the security risk.

17. A computer data signal embodied in a digital data stream comprising data relating to a managing security risk, wherein the computer data signal is operative with a computer for causing the computer to:
set a hierarchical relationship between two or more elements comprising an entity;
receive an indication of a security risk associated with one or more of the elements;
receive a selection of an element;
transmit a description of the security risk as it relates to the element selected, based upon the hierarchical relationship of elements and the indication of the security risk.

18. The computer data signal of claim 17 wherein the data signal is generated by a method additionally comprising the step of generating a suggested action based upon the indication of a security risk and the elements comprising the entity.
